(19) United States
(12) Patent Application Publication
(10) Pub. No.: US 2013/0323439 A1
(43) Pub. Date: Dec. 5, 2013

(54) OPTICAL EFFECT DISC AND OPTICAL RECORDING MEDIA COMBINING THE SAME

(71) Applicants: Yung-Hui Hung, Taipei City (TW); Cheng-Pi Lee, Taipei City (TW); Min-Hao Pan, Taipei City (TW); Yao-Kai Kuo, Taipei City (TW)

(72) Inventors: Yung-Hui Hung, Taipei City (TW); Cheng-Pi Lee, Taipei City (TW); Min-Hao Pan, Taipei City (TW); Yao-Kai Kuo, Taipei City (TW)

(73) Assignee: CMC MAGNETICS CORPORATION, Taipei City (TW)

(21) Appl. No.: 13/570,775

(22) Filed: Aug. 9, 2012

(30) Foreign Application Priority Data
May 31, 2012 (TW) 101210509

(51) Int. Cl. G11B 7/252; G02B 3/00; G02B 5/18; G02B 5/32

(52) U.S. Cl. 428/29; 428/64.4; 428/65.2; 359/15; 359/619; 359/567

(57) ABSTRACT

An optical effect disc, has a transparent substrate and a surface optical structure, and an optical recording media combining the optical effect disc. The surface optical structure may be a computer-generated hologram optical structure or a micro-lens array structure for showing the effect of brightening or peep prevention, or a diffraction gating structure for achieving a three-dimensional visual effect. The optical effect disc or the optical recording media may include an image forming layer for forming an image to be shown by the optical effect disc with corresponding visual effect. The optical effect disc or the optical recording media may include an adhesive layer for attaching the optical effect disc to the optical recording media.

### FIELD OF THE INVENTION

The present invention relates to an optical effect disc and an optical recording media combining the same, and particularly to an optical effect disc for achieving a three-dimensional visual effect and an optical recording media combining the same.

### BACKGROUND

In the field of recording media, optical discs and related products utilizing optical reading and recording such as CD, CD-R, CD-RW, DVD, DVD-R, DVD+R, DVD-RW, DVD+RW, BD, BD-R or BD-RE are widely used for data storage. The major structure of an optical disc includes a substrate, an optical recording layer formed on a side of the substrate for recording and reading digital information, and a coating layer printable with images, which is formed on the optical recording layer or on an opposite side of the substrate to the optical recording layer, thus allowing manufacturers or users for printing or screen printing images on the coating layer. However, the coating layer either includes the printed images by the manufacturers, or is a blank coating layer for the users to write or print images thereon. Thus, only two-dimensional images or texts can be formed on the coating layer, which is dull and has no difference from general printing materials.

To provide lively visual effects for the optical discs, the inventor has disclosed an invention in a Taiwan Patent Application No. 100144352, titled “Optical Recording Media with Visual Effect Marking Layer”, for providing three-dimensional visual effects to the optical discs.

However, the invention proposed by the inventor provides three-dimensional visual effects to the optical discs, but does not allow the users to selectively choose or print images as desired. With all customization and DIY requirements in recent days, if can let users form the images as desired on the optical discs with three-dimensional visual effects, then can more satisfy the need of the users.

### SUMMARY OF THE INVENTION

To provide a variety of visual effects for the optical recording media, the present invention provides an optical effect disc for combining with an optical recording media, including a transparent substrate having a surface optical structure. The optical effect disc may further include an adhesive layer for adhering the optical effect disc to the optical recording media, such that the images on the optical recording media would show visual effects through the surface optical structure. The surface optical structure may be a computer-generated hologram optical structure or a micro-lens array structure for showing the effect of brightening or peep prevention, or for example ,a diffraction gating structure for achieving a three-dimensional visual effect. Furthermore, for the optical effect disc having the diffraction gating structure, the present invention also provides an optical recording media, including a substrate, an optical recording layer and an image forming layer. The optical recording layer and the image forming layer are formed on the two sides of the substrate. The user or manufacturer may form an image on the image forming layer with the design corresponding to the diffraction gating structure for the three-dimensional visual effect. As the diffraction gating structure has directivity, the image printed must correspond to the direction of the gating. Thus, the optical effect disc and the optical recording media may have corresponding structure or mark for aligning in printing images or adhering.

Further, the combination of the optical effect disc and the optical recording media has to form an image on the recording media. In an example of the optical disc, an industrial screen printer is require for printing on the optical disc, which is inconvenient for the general users. Thus, the present invention discloses an optical effect disc, which includes a transparent substrate having a surface optical structure formed thereon, and an image forming layer. The image forming layer may be formed on an opposite side of the substrate oppose to the surface optical structure. The image forming layer is configured to form an image, and the image is configured to be shown by the the surface optical structure with the three-dimensional visual effect. Since the image forming layer is positioned on the optical effect disc, which is generally thinner and more flexible, and not on the optical disc, a general printer can be used more conveniently for printing the image. Similarly, the surface optical structure on the optical effect disc may be a computer-generated hologram optical structure or a micro-lens array structure for showing the effect of brightening or peep prevention, or for example, a diffraction gating structure for achieving a three-dimensional visual effect. For the optical effect disc having the diffraction gating structure, a direction mark may be further provided for marking the direction of the diffraction gating structure for aligning in printing. To correspond to the optical effect disc having the image forming layer, the present invention discloses an optical recording media, which includes a substrate, an optical recording layer, and an adhesive layer formed on the optical recording layer or on an opposite side of the substrate of the optical recording layer. The optical effect disc may be adhered to the optical recording media by the adhesive layer

### BRIEF DESCRIPTION OF THE DRAWINGS

FIG. 1 is a schematic view of an optical effect disc according to a first embodiment of the present invention.

FIG. 2 is a schematic view of an optical effect disc and an optical recording media according to a second embodiment of the present invention.

FIG. 3 is a schematic view of an optical effect disc according to a third embodiment of the present invention.

FIG. 4 is a schematic view of an optical effect disc and an optical recording media according to a fourth embodiment of the present invention.

### DETAILED DESCRIPTION OF THE INVENTION

The techniques employed by the present invention to achieve the foregoing objectives, characteristics and effects thereof are described hereinafter by way of examples with reference to the accompanying drawings, which do not illustrate the full structure and exact dimensions of the actual object. A part of the drawings include exploded or dissembled views of the structure. However, the actual structure are combinations of the layers and the substrate, and may include other layer structures therebetween.

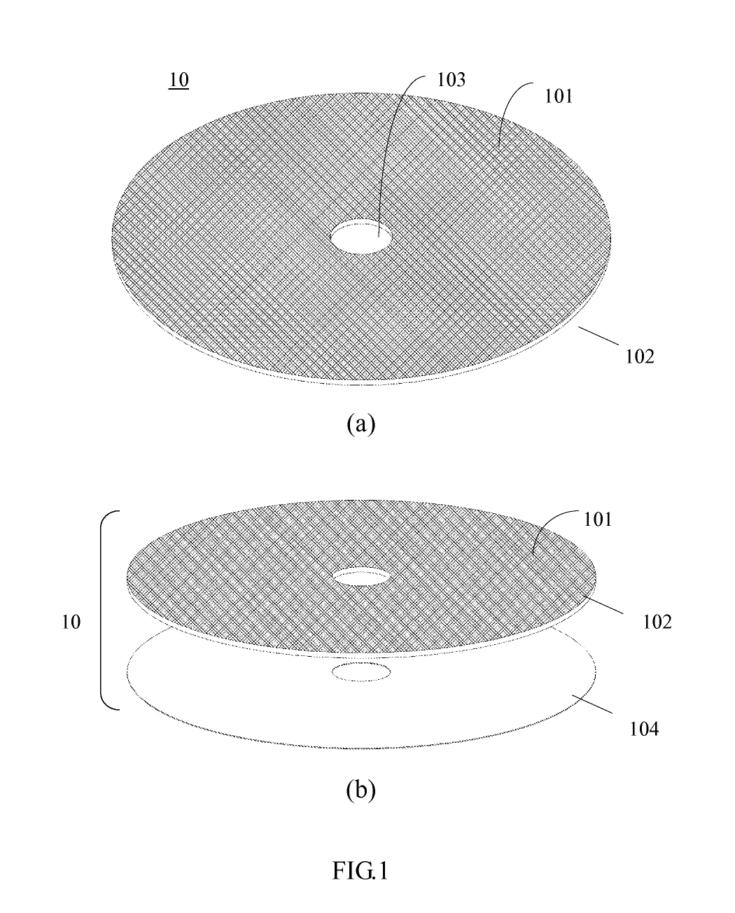

The first embodiment of the present invention is shown as FIG. 1, where figure (a) shows an optical effect disc 10 for combining with an optical recording media. The optical effect disc 10 includes a transparent substrate 102 having a surface optical structure. In this embodiment, the surface optical structure is a micro-lens array 101. The micro-lens array 101 method has the function of changing the emergence angle of the light, and with proper design, light passing through the micro-lens array 101 may be limited within a certain range for achieving the effect of brightening or peep prevention. The shape of the optical effect disc 10 can be designed differently in correspondence to the optical recording media, and in this embodiment, the optical effect disc 10 is in a circular shape with a circular hole 103 at the middle thereof for combining with an optical disc. A user may attach the optical effect disc 10 onto an optical disc with images formed thereon by adhesive. The images may be formed when the optical disc is manufactured, such as a commercially sold music CD or video DVD, BD, but not included commercially sold music CD or may be printed on a printable layer of the optical disc by the user.

A variety of change can be made to the first embodiment of the present invention. For example, the surface optical structure of the optical effect disc 10 may be a computer-generated hologram optical structure, which is obtained according to a design by computer calculation (such as Fourier Transformation) for the required optical effect. Furthermore, as shown in figure (b) of FIG. 1, for convenient use, the optical effect disc 10 may further include an adhesive layer 104, such as a coating of an adhesive resin on an opposite side to the surface optical structure, or twin adhesive. Moreover, the optical effect disc 10 as shown in FIG. 1 covers the whole optical disc. However, the optical effect disc 10 may be of certain shapes to cover only a part of the surface of the optical disc, such as a semi-circular shape, a fan shape, or a circular shape with a radius shorter than that of the optical disc.

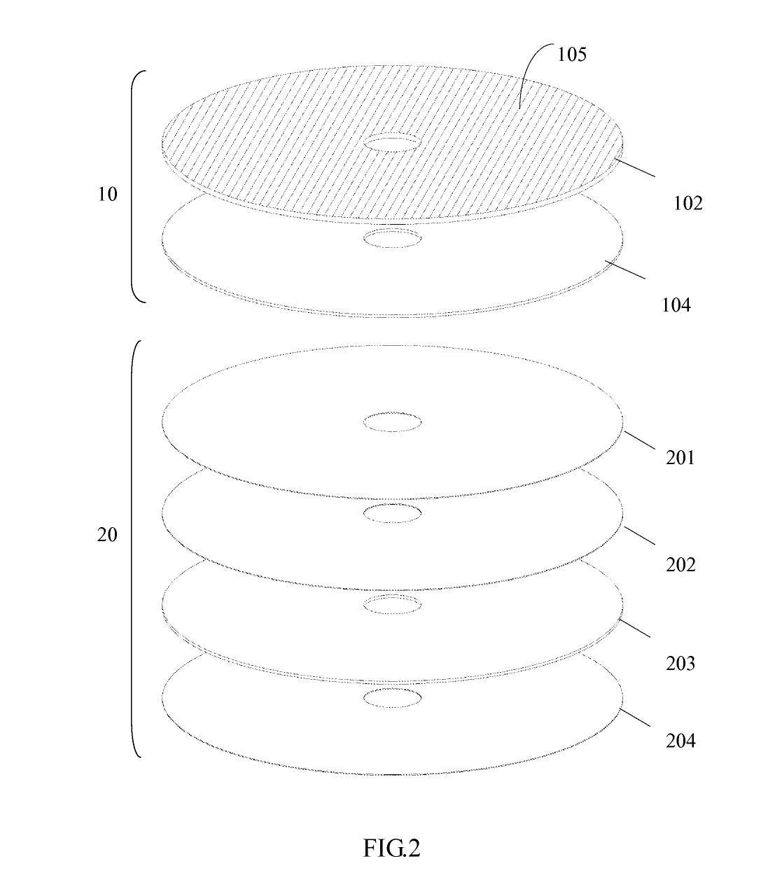

The second embodiment of the present invention is shown as FIG. 2, which shows an optical effect disc 10 having a diffraction gating structure 105 thereon, and an optical recording media 20 is for combining the optical effect disc 10. The optical recording media 20 includes a substrate 203, an optical recording layer 204, and an image forming layer 201 configured to form an image thereon, either by the manufacturer producing the batch printing, or by the user using a printer. For showing vivid colors of the image, a white coating layer 202 is generally formed between the image forming layer 201 and the substrate 203. Furthermore, for different forms of the optical recording media, it is also suitable that the optical recording layer 204 is positioned between the substrate 203 and the white coating layer 202. An objective of the embodiment is to show the image on the optical recording media 20 with a three-dimensional visual effect. Thus, the image has to be printed corresponding to the diffraction gating structure 105. When a user self prints the image, computer software applications that can process a two-dimensional image corresponding to the gating, such as Adobe Photoshop or other image processing software, may be used to process the two-dimensional image to obtain a three-dimensional image according to the standard of the gating structure (generally the pitch of the gating) such that the image may be shown by the diffraction gating structure 105 to generate the three-dimensional visual effect. Moreover, a printer that can print the image on the printable layer of the optical disc, such as Epson PP-100 or other printing machines supporting optical disc printing, may be used to form the processed three-dimensional image on the image forming layer 201 of the optical recording media 20.

In the second embodiment, since the diffraction gating structure 105 has its directivity, the three-dimensional image processed by the software must correspond to the direction of the gating structure to show the expected effect. Thus, in this embodiment, the optical recording media 20 and the optical effect disc 10 having the diffraction gating structure 105 may have corresponding aligning structures or marks (not shown in the figure) for aligning in combination. The aligning structures may be corresponding protrusions/concaves or interlocking structures, and the aligning marks may be dots or gaps at the edges. Furthermore, the aligning structures and marks on the optical recording media 20 may be used for confirming the direction of printing to the printer.

Similarly, in the second embodiment, the user may adhere the optical effect disc 10 and the optical recording media 20 by adhesives. For convenient use, the optical effect disc 10 may further include an adhesive layer 104, such as a coating of an adhesive resin on an opposite side to the diffraction gating structure 105, or twin adhesive. Moreover, the optical effect disc 10 may cover the whole optical disc, or may cover only a part of the surface of the optical disc.

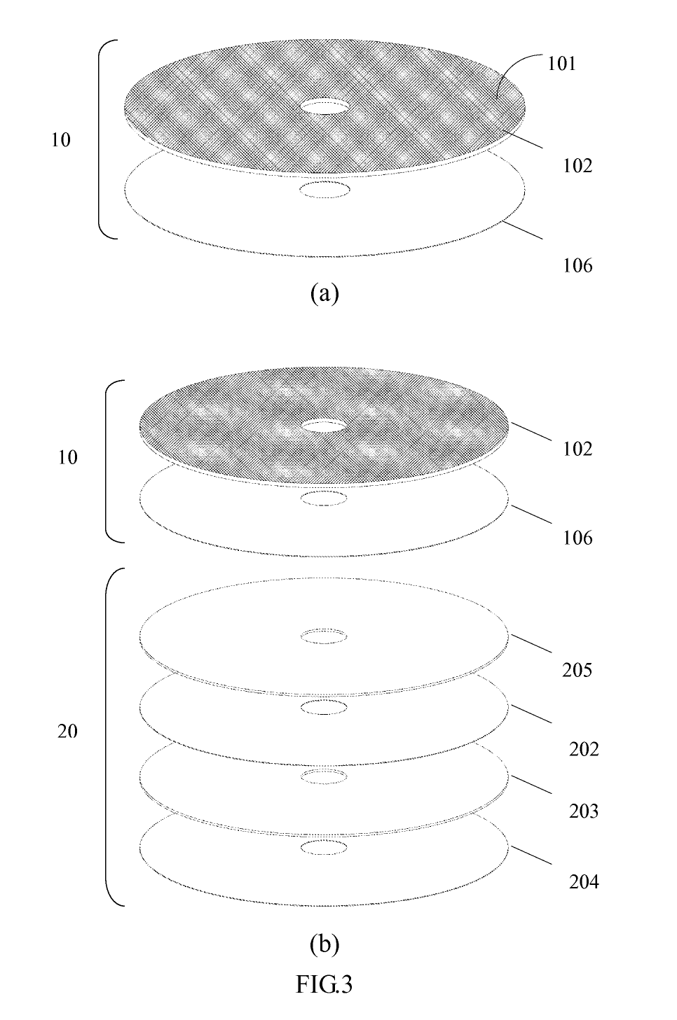

The third embodiment of the present invention is shown as FIG. 3, where figure (a) shows an optical effect disc 10 for combining with an optical recording media. The optical effect disc 10 includes a transparent substrate 102 having a surface micro-lens array structure 101, and an image forming layer 106, which may be formed on an opposite side of the transparent substrate 102 to the micro-lens array 101. As described in the first embodiment, the micro-lens array 101 may achieve the effect of brightening or peep prevention. The shape of the optical effect disc 10 can be designed differently in correspondence to the optical recording media 20, and in this embodiment, the optical effect disc 10 is in a circular shape with a circular hole at the middle thereof for combining with an optical disc. The user or the manufacturer may form the image on the image forming layer 106 of the optical effect disc 10 by a printer or other printing or screen printing device. After forming the image, the user may attach the optical effect disc 10 onto the optical recording media 20 by adhesives.

In the third embodiment of the present invention, the surface optical structure of the optical effect disc 10 may be a computer-generated hologram optical structure, which is obtained according to a design by computer calculation (such as Fourier Transformation) for the required optical effect. Furthermore, as shown in figure (b) of FIG. 3, the embodiment may further include an optical recording media 20 for combing the optical effect disc 10. The optical recording media 20 may include an adhesive layer 205 formed thereon, such as a coating of an adhesive resin on a surface of the optical recording media 20, or twin adhesive. Moreover, the optical effect disc 10 may cover the whole optical disc, or may cover only a part of the surface of the optical disc. In this case, the shape of the adhesive layer 205 of the optical recording media 20 must be changed according to the shape of the optical effect disc 10.

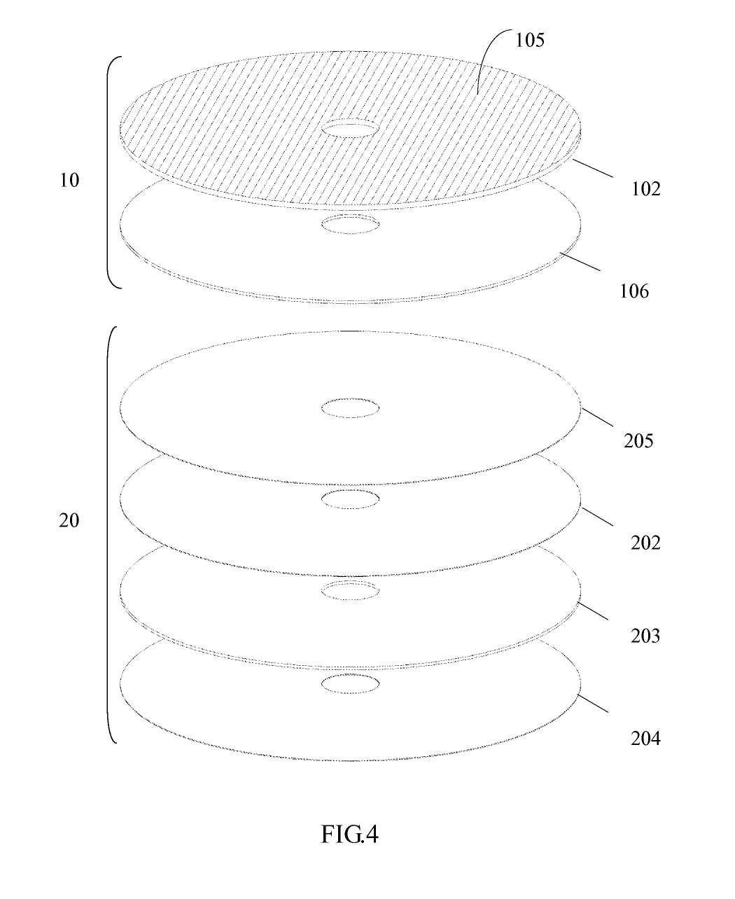

The fourth embodiment of the present invention is shown as FIG. 4, which shows an optical effect disc 10 having a diffraction gating structure 105 thereon, and an optical recording media 20 is for combining the optical effect disc 10. The optical effect disc 10 has an image forming layer 106, which is positioned on an opposite side of the transparent substrate 102 to the diffraction gating structure 105. The image forming layer 106 may be provided for screen printing images thereon by the manufacturer or for printing images by the user with a printer. An objective of the embodiment is to show the image on the image forming layer 106 with an three-dimensional visual effect. Thus, the image has to be printed corresponding to the diffraction gating structure 105. When a user self prints the image, computer software applications that can process a two-dimensional image corresponding to the gating, such as Adobe Photoshop or other image processing software, may be used to process the two-dimensional image to obtain a three-dimensional image according to the standard of the gating structure (generally the pitch of the gating) such that the image may be shown by the diffraction gating structure 105 to generate the three-dimensional visual effect.

In the fourth embodiment, since the diffraction gating structure 105 has its directivity, the three-dimensional image processed by the software must correspond to the direction of the gating structure to show the expected visual effect. Thus, in this embodiment, the optical effect disc 10 having the diffraction gating structure 105 may have corresponding aligning marks (not shown in the figure) for confirming the direction of printing by the printer. The aligning marks may be dots or gaps at the edges.

Similarly, in the fourth embodiment, the user may adhere the optical effect disc 10 and the optical recording media 20 by adhesives. For convenient use, the optical recording media 20 may further include an adhesive layer 205, such as a coating of an adhesive resin on an opposite side to the optical recording layer, or twin adhesive. Moreover, the optical effect disc 10 may cover the whole optical recording media 20, or may cover only a part of the surface of the optical recording media 20.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. An optical effect disc for combining with an optical recording media, comprising:
a transparent substrate; and
a surface optical structure formed on a side of the transparent substrate.

2. The optical effect disc as claimed in claim 1, further comprising an adhesive layer configured to combine the optical effect disc with the optical recording media by adhering.

3. The optical effect disc as claimed in claim 2, wherein the adhesive layer is formed on an opposite side of the transparent substrate to the surface optical structure.

4. The optical effect disc as claimed in claim 1, wherein the surface optical structure is a computer-generated hologram optical structure or a micro-lens array structure for achieving the effect of brightening or peep prevention.

5. The optical effect disc as claimed in claim 1, wherein the surface optical structure is a diffraction gating structure for achieving a three-dimensional visual effect.

6. An optical recording media for combining the optical effect disc as claimed in claim 5, the optical recording media comprising:
a substrate;
an optical recording layer formed on a side of the substrate; and
an image forming layer;
wherein the image forming layer is configured to form an image, and the image is configured to be shown by the optical effect disc with the three-dimensional visual effect.

7. The optical recording media as claimed in claim 6, wherein the image forming layer is formed on an opposite side of the substrate to the optical recording layer.

8. The optical recording media as claimed in claim 6, further comprising a white coating layer formed between the image forming layer and the substrate.

9. The optical recording media as claimed in claim 6, wherein the optical recording media is an optical disc.

10. An optical effect disc, comprising:
a transparent substrate;
a surface optical structure formed on a side of the transparent substrate;
an image forming layer formed on an opposite side of the transparent substrate to the surface optical structure;
wherein the image forming layer is configured to form an image, and the image is configured to be shown by the surface optical structure with a three-dimensional visual effect.

11. The optical effect disc as claimed in claim 10, wherein the surface optical structure is a computer-generated hologram optical structure or a micro-lens array structure for showing the image with a brightening or peep prevention visual effect.

12. The optical effect disc as claimed in claim 10, wherein the surface optical structure is a diffraction gating structure for showing the image with the three-dimensional visual effect.

13. The optical effect disc as claimed in claim 10, further comprising a direction marking for showing a direction of the diffraction gating structure.

14. An optical recording media for combining the optical effect disc as claimed in any of claim 10, the optical recording media comprising:
a substrate;
an optical recording layer formed on a side of the substrate; and
an adhesive layer;
wherein the optical effect disc is adhered to the optical recording media by the adhesive layer.

15. The optical recording media as claimed in claim 14, wherein the adhesive layer is formed on an opposite side of the substrate to the optical recording layer.

16. The optical recording media as claimed in claim 14, further comprising a white coating layer formed between the adhesive layer and the substrate.

17. The optical recording media as claimed in claim 14, wherein the optical recording media is an optical disc.

18. An optical recording media for combining the optical effect disc as claimed in any of claim 11, the optical recording media comprising:
a substrate;
an optical recording layer formed on a side of the substrate; and
an adhesive layer;
wherein the optical effect disc is adhered to the optical recording media by the adhesive layer.

19. An optical recording media for combining the optical effect disc as claimed in any of claim 12, the optical recording media comprising:
a substrate;
an optical recording layer formed on a side of the substrate; and
an adhesive layer;
wherein the optical effect disc is adhered to the optical recording media by the adhesive layer.

20. An optical recording media for combining the optical effect disc as claimed in any of claim 13, the optical recording media comprising:
a substrate;
an optical recording layer formed on a side of the substrate; and
an adhesive layer;
wherein the optical effect disc is adhered to the optical recording media by the adhesive layer.
